(19) United States
(12) Patent Application Publication
(10) Pub. No.: US 2004/0137296 A1
(43) Pub. Date: Jul. 15, 2004

(54) Fuel cell

(76) Inventors: Werner Schunk, Gotha (DE); Michael Bruder, Hamburg (DE); Uwe Heiber, Erfurt (DE); Karl-Heinz Krause, Chemnitz (DE); Gerhard Merkmann, Gotha (DE)

Correspondence Address: WILLIAM COLLARD, COLLARD & ROE, P.C., 1077 NORTHERN BOULEVARD, ROSLYN, NY, 11576, US

(21) Appl. No.: 10/476,046

(22) PCT Filed: Apr. 25, 2002
(86) PCT No.: PCT/DE02/01518

(30) Foreign Application Priority Data
Apr. 25, 2002 (DE) 101 24 713.3

(51) Int. Cl. H01M 8/10

(52) U.S. Cl. 429/30; 429/38; 429/33

(57) ABSTRACT

The invention relates to a fuel cell (1) comprising at least the following components: a proton-conducting membrane (2) serving as an electrolyte; catalyst layers (3), which cover the membrane (2) on both sides; gas-permeable electrodes provided in the form of an anode (4) and a cathode (5), which rest against the outwardly pointing surface of the catalyst layers (3), and; electrically conductive plates (6), which contact the electrodes in an electrically conductive manner whereby being located close to one another and which, together with the electrodes, delimit gas-conducting channels. The fuel cell also comprises gas connections for supplying hydrogen (H₂) on one side and oxygen (O₂) on the other. The inventive fuel cell (1) is characterized in that the membrane (2) has a matrix into which a proton-conducting organic-based polymer substance is incorporated.

The invention relates to a fuel cell comprising at least the following components:

a proton-conducting membrane serving as an electrolyte;

catalyst layers which cover the membrane on both sides;

gas-permeable electrodes in the form of an anode and a cathode, which rest against the outwardly pointing surface of the catalyst layers;

electrically conductive plates, which contact the electrodes in an electrically conductive manner at closely adjacent intervals and, together with the electrodes, delimit gas-conductive channels; as well as

gas connections for supplying hydrogen on one side and oxygen on the other side.

A fuel cell of this type is described in detail, for example, in the following references, namely DE-A-36 40 108, DE-A-195 44 323, WO-A-94/09519, WO-A-01/28023, U.S. Pat. No. 5,292,600, and in “Spektrum der Wissenschaft” [Spectrum of Science] (July 1995), pages 92 to 98.

Fuel cells are electrochemical energy converters and are comparable with battery systems, which convert stored chemical energy into current. In contrast to today's conventional current generators, current generation in a fuel cell takes place without the detour of heat generation.

The core of a fuel cell is the membrane, which is allowed to be permeable only for hydrogen ions (protons). On the one side, hydrogen flows past the catalysts (e.g. platinum catalysts), and in doing so, is split into protons and electrons; on the other side, air or pure oxygen flows past. The protons pass through the membrane and combine with the oxygen to form water, together with the electrons that function as active current; the water remains as the only waste product. In other words, the hydrogen passes the electrons off at the one electrode, the oxygen takes them over at the other electrode.

Currently, plastic membranes are used in fuel cells, in most cases. The materials in this regard are particularly polysulfones (DE-A-198 09 119), thermoplastic polyether ketones, and polytetrafluoroethylene with sulfonic perfluorovinyl ether side chains (Naflon 117, DuPont).

Furthermore, an elastomer membrane in the form of a vulcanized rubber mixture on the basis of a halogenated rubber is presented in the Published Application WO-A-01/28023, whereby a carrier material is added for the purpose of increasing the proton conductivity of the rubber mixture, which material is charged with an inorganic acid (e.g. phosphoric acid).

Up to now, the goal was to produce membranes whose basic material, which forms the membrane structure, is proton-conducting, specifically without additives, if possible. In this manner, it was possible to use materials (e.g. Naflon) having a high proton-conducting efficiency. However, it then frequently has to be accepted that these materials have their limits with regard to structural strength and other requirements of a mechanical, physical and/or chemical nature. The operating temperature also had a not insignificant influence on the proton-conducting performance capacity of these materials.

Additionally mixing in a carrier material charged with an acid, again, resulted in the acid being washed out in most cases.

The task of the invention is now to make available a proton-conducting membrane whose basic material does not itself have to be proton-conducting, so that a broad spectrum of materials is available to fuel cell technology.

The fuel cell according to the invention, using a membrane comprising a matrix into which a proton-conducting, organic-based polymer substance (ion conductor) is incorporated, takes a new path in terms of material technology combined with a high efficiency of proton conductivity, and, at the same time, technically simple and cost-effective production.

The polymer substance has a low molecular weight, specifically an average molecular weight of at least 1,000, particularly at least 1,500. Here, the average molecular weight is a maximum of 5,000.

As an alternative to this, the polymer substance can also have a high molecular weight, specifically an average molecular weight greater than 5,000. In this case, the average molecular weight is a maximum of 50,000, particularly a maximum of 20,000.

The polymer substance has functional groups, preferably carboxyl groups and/or sulfonic acid groups, particularly, again, with the aspect of salt formation (sodium salt). In contrast to the carrier materials charged with acids, washing out does not take place.

The proportion of the matrix, as the base material into which the proton-conducting polymer substance is incorporated, amounts to 20 to 50% by weight, specifically with reference to the membrane. The proportion of the polymer substance, i.e. the adduct formed by a carrier material and the polymer substance comprises 80 to 50% by weight. The adduct formation will be discussed in greater detail at another point.

The matrix of the membrane can be a polymer material, preferably a thermoplastic plastic, an elastomer, or a thermoplastic elastomer.

The thermoplastic plastic is preferably based on a halogenated and/or sulfonated polyalkene, particularly, again, a halogenated and/or sulfonated polyethylene.

As an alternative to this, an elastomer based on a rubber having a non-polar or a polar nature can also be used, whereby the following rubber types are particularly used:

natural rubber (abbreviation: NR)

butadiene rubber (abbreviation: BR)

mixed ethylene-propylene-diene polymerizate (abbreviation: EPDM)

fluorine rubber (abbreviation: FKM)

chloroprene rubber (2-chlorobutadiene-1,3; abbreviation: CR)

chlorobutyl rubber (abbreviation: CIIR)

bromobutyl rubber (abbreviation: BIIR)

nitrile rubber (abbreviation: NBR), particularly carboxylated NBR

acrylate rubber (abbreviation: ACM)

polyoxide rubber (abbreviation: POR)

polypropyl oxide rubber (abbreviation: PPOR)

Thermoplastic elastomers, particularly in combination with the aforementioned materials, can also be used, whereby the proportion of the thermoplastic components is ≧ the proportion of the elastomer component.

If the matrix is an elastomer or a thermoplastic elastomer, it also contains other conventional mixture ingredients, particularly a cross-linking agent for the rubber. These ingredients are a subsystem of the matrix and are connected with the total amount information of the matrix.

The polymer matrix on the basis of the aforementioned materials forms a blend or a block copolymerizate with the proton-conducting polymer substance in most cases.

It is advantageous if the matrix, particularly the polymer matrix presented in greater detail here, additionally contains a carrier material, for example a molecular screen with or without water of crystallization. This carrier material is now charged with the polymer substance as an ion conductor, specifically forming a corresponding adduct. The proportion of the polymer substance is ≦60% by weight, particularly ≦50% by weight, specifically with reference to the adduct.

The matrix of the membrane can also be a nonwoven fabric formed of fibers, whereby the nonwoven fabric is saturated or coated with the polymer substance.

The invention will now be explained on the basis of schematic representations. These show:

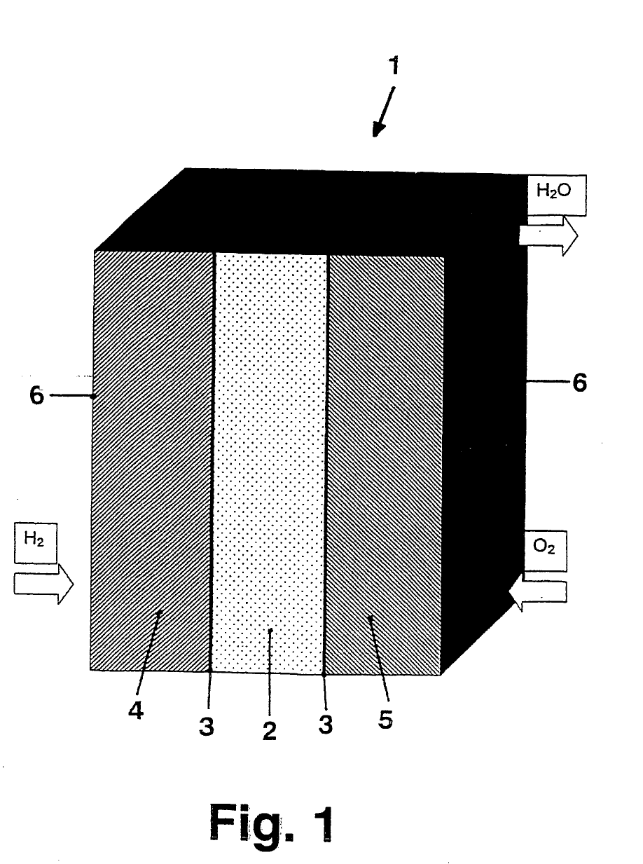

FIG. 1 a fuel cell;

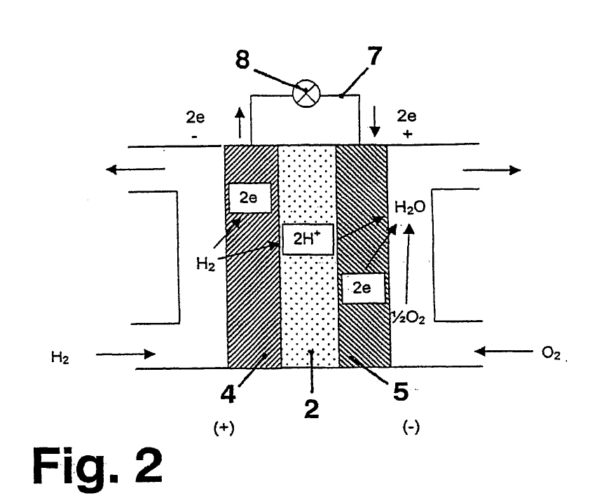

FIG. 2 the electrochemical reaction sequence of a fuel cell.

According to FIG. 1, the fuel cell 1 comprises a membrane 2 serving as an electrolyte, comprising a matrix into which a proton-conducting, organic-based polymer substance is incorporated. In this connection, the membrane 2 is covered on both sides by catalyst layers 3. Gas-permeable electrodes in the form of an anode 4 and a cathode 5 rest on the outwardly pointing surface of the catalyst layers 3. The electrically conductive plates 6 delimit the fuel cell on the anode and cathode side, respectively, whereby these plates form a structural unit with the gas-permeable electrodes. Furthermore, gas connections for the hydrogen (H₂) and oxygen (O₂) are present.

Several individual cells 1 can now be combined into cell stacks, whereby the membrane contributes to a low overall structural space, at a layer thickness of mostly 0.05 to 0.1 mm, particularly 0.1 to 0.2 mm.

FIG. 2 shows the electrochemical reaction sequence of a fuel cell, with the following individual sequences:

first individual reaction at the anode 4 (H₂->2H⁺+2e);

proton migration through the membrane 2;

electron flow by way of an external current circuit 7, which is connected with an electrical consumer 8;

second individual reaction at the cathode 5 (2H⁺+2e+½O₂->H₂O).

Since it would be too expensive to replace the existing gas station network with a hydrogen network, development is going in the direction of generating the hydrogen directly on board the car, preferably from methanol, which can easily be obtained from natural gas or also from renewable raw materials, and which can be tanked like gasoline. For this purpose, a reformation reactor as a small chemical plant is required. Furthermore, a direct methanol fuel cell having an internal reformer, using a reformer layer, is known (DE-A-199 45 667).

Air is generally sufficient as a source of oxygen.

The membrane can be used for a low-temperature fuel cell at an operating temperature <100° C.

The advantage of the new type of membrane is that even materials that have no proton conductivity or only low proton conductivity, but have other advantageous material properties, for example natural rubber, are activated to be proton-conducting by incorporating the ion conductor.

### Reference Symbol List

1 fuel cell (individual cell)

2 proton-conducting membrane

3 catalyst layer

4 electrode (anode)

5 electrode (cathode)

6 electrically conductive plate (bipolar plate)

7 external current circuit

8 electrical consumer

1. Fuel cell (1), comprising at least the following components:
a proton-conducting membrane (2) serving as an electrolyte;
catalyst layers (3) which cover the membrane (2) on both sides;
gas-permeable electrodes in the form of an anode (4) and a cathode (5), which rest against the outwardly pointing surface of the catalyst layers (3);
electrically conductive plates (6), which contact the electrodes in an electrically conductive manner at closely adjacent intervals and, together with the electrodes, delimit gas-conductive channels; as well as
gas connections for supplying hydrogen on one side and oxygen on the other side;
characterized in that
the membrane (2) comprises a matrix into which a proton-conducting, organic-based polymer substance is incorporated.

2. Fuel cell according to claim 1, characterized in that the polymer substance has a low molecular weight, specifically an average molecular weight of at least 1,000, particularly at least 1,500.

3. Fuel cell according to claim 2, characterized in that the average molecular weight is a maximum of 5,000.

4. Fuel cell according to claim 1, characterized in that the polymer substance has a high molecular weight, specifically an average molecular weight greater than 5,000.

5. Fuel cell according to claim 4, characterized in that the average molecular weight is a maximum of 50,000, particularly a maximum of 20,000.

6. Fuel cell according to one of claims 1 to 5, characterized in that the polymer substance has functional groups, preferably carboxyl groups and/or sulfonic acid groups.

7. Fuel cell according to claim 6, characterized in that the polymer substance forms a salt of the first or second main group of the periodic system, preferably a sodium salt.

8. Fuel cell according to one of claims 1 to 7, characterized in that the proportion of the matrix amounts to 20 to 50% by weight, specifically with reference to the membrane (2).

9. Fuel cell according to one of claims 1 to 8, characterized in that the matrix of the membrane (2) is a polymer material, preferably a thermoplastic plastic, an elastomer, or a thermoplastic elastomer.

10. Fuel cell according to claim 9, characterized in that a thermoplastic plastic based on a halogenated and/or sulfonated polyalkene is used.

11. Fuel cell according to claim 10, characterized in that a halogenated and/or sulfonated polyethylene is used.

12. Fuel cell according to claim 9, characterized in that an elastomer based on a rubber having a non-polar nature is used.

13. Fuel cell according to claim 12, characterized in that natural rubber, butadiene rubber, or a mixed ethylene-propylene-diene polymerizate is used.

14. Fuel cell according to claim 9, characterized in that an elastomer based on a rubber having a polar nature is used.

15. Fuel cell according to claim 14, characterized in that a halogenated rubber on the basis of fluorine, chlorine, or bromine is used.

16. Fuel cell according to claim 15, characterized in that fluorine rubber, chloroprene rubber, chlorobutyl rubber, or particularly bromobutyl rubber is used.

17. Fuel cell according to claim 14, characterized in that nitrile rubber is used.

18. Fuel cell according to claim 14, characterized in that acrylate rubber is used.

19. Fuel cell according to claim 14, characterized in that polyoxide rubber, preferably polypropyl oxide rubber, is used.

20. Fuel cell according to claim 14, characterized in that carboxylated rubber, preferably carboxylated nitrile rubber, is used.

21. Fuel cell according to claim 9, characterized in that the thermoplastic elastomer is formed from a thermoplastic component according to claim 10 or 11 and an elastomer component according to one of claims 12 to 20.

22. Fuel cell according to claim 21, characterized in that the proportion of the thermoplastic components is ≧ the proportion of the elastomer component.

23. Fuel cell according to one of claims 1 to 22, characterized in that additionally, a carrier material is incorporated into the matrix (2).

24. Fuel cell according to claim 23, characterized in that the carrier material is charged with the polymer substance, specifically forming a corresponding adduct.

25. Fuel cell according to claim 24, characterized in that the proportion of the polymer substance is ≦60% by weight, particularly ≦50% by weight, specifically with reference to the adduct.

26. Fuel cell according to one of claims 1 to 8, characterized in that the matrix of the membrane is a nonwoven fabric formed of fibers.

27. Fuel cell according to claim 26, characterized in that the nonwoven fabric is saturated with the polymer substance.

28. Fuel cell according to claim 26, characterized in that the nonwoven fabric is coated with the polymer substance.
